(19) United States
(12) Patent Application Publication
(10) Pub. No.: US 2023/0409324 A1
(43) Pub. Date: Dec. 21, 2023

(54) COMPUTER-READABLE RECORDING MEDIUM STORING ARITHMETIC PROCESSING PROGRAM AND ARITHMETIC PROCESSING METHOD

(71) Applicant: Fujitsu Limited, Kawasaki-shi (JP)

(72) Inventor: Katsuhiro YODA, Kodaira (JP)

(73) Assignee: Fujitsu Limited, Kawasaki-shi (JP)

(21) Appl. No.: 18/160,321

(22) Filed: Jan. 27, 2023

(30) Foreign Application Priority Data
Jun. 8, 2022 (JP) 2022-093140

(51) Int. Cl. G06F 9/30; G06F 9/38

(52) U.S. Cl. CPC G06F 9/30138; G06F 9/384

(57) ABSTRACT

A non-transitory computer-readable recording medium stores an arithmetic processing program for causing a computer to execute a process including: setting, in a mask register used for a mask operation, to each of a plurality of mask bits that indicates a bit corresponding to each element of each row of a sparse matrix, each mask pattern for designating the mask operation; and expanding the plurality of mask bits to which the respective mask patterns are set to different areas of a physical register, respectively.

### CROSS-REFERENCE TO RELATED APPLICATION

This application is based upon and claims the benefit of priority of the prior Japanese Patent Application No. 2022-93140, filed on Jun. 8, 2022, the entire contents of which are incorporated herein by reference.

### FIELD

The embodiments discussed herein are related to a computer-readable recording medium storing an arithmetic processing program and an arithmetic processing method.

### BACKGROUND

As a method of performing an arithmetic operation on a sparse matrix at high speed, single instruction multiple data (SIMD) for performing an arithmetic operation on a plurality of rows at one time is used. At the time of parallelization by SIMD, when the number of elements differs for each row, parallelization is realized by using a mask technique.

Japanese National Publication of International Patent Application No. 2018-500652, Japanese Laid-open Patent Publication No. 2017-62845, U.S. Patent No. 2016/0188336, and U.S. Patent No. 2012/0151182 are disclosed as related art.

### SUMMARY

According to an aspect of the embodiments, a non-transitory computer-readable recording medium stores an arithmetic processing program for causing a computer to execute a process including: setting, in a mask register used for a mask operation, to each of a plurality of mask bits that indicates a bit corresponding to each element of each row of a sparse matrix, each mask pattern for designating the mask operation; and expanding the plurality of mask bits to which the respective mask patterns are set to different areas of a physical register, respectively.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a functional block diagram illustrating a functional configuration included in a processor of an information processing apparatus according to Embodiment 1;

FIG. 2 is a diagram for explaining parallel operations of a sparse matrix according to Embodiment 1;

FIG. 3 is a diagram for explaining a mask operation;

FIG. 4 is a diagram for explaining an element mask of reduced instruction set computer (RISC)-V;

FIG. 5 is a diagram for explaining a problem due to replacement of a mask pattern;

FIG. 6 is a diagram for explaining generation of a mask pattern by a right shift;

FIG. 7 is a diagram for explaining occurrence of a dependency relationship;

FIG. 8 is a diagram for explaining rename processing;

FIG. 9 is a diagram for explaining an example of resolving a dependency relationship by renaming;

FIG. 10 is a diagram for explaining rename processing in Embodiment 1;

FIG. 11 is a diagram for explaining effects according to Embodiment 1;

FIG. 12 is a flowchart for explaining a flow of the rename processing in Embodiment 1;

FIG. 13 is a flowchart for explaining a flow of release processing in Embodiment 1;

FIG. 14 is a diagram for explaining release determination in the release processing; and

FIG. 15 is a diagram for explaining a hardware configuration example.

### DESCRIPTION OF EMBODIMENTS

However, in the above-described technique, a mask pattern that may be generated is to be prepared in advance, thus a large number of logical registers are to be used for creating the mask pattern, and there is a risk for the logical registers to be depleted. A technique for resolving depletion of the logical registers by allocating a physical register to a register number by using a renamer has also been known, but when the renamer is used, a dependency relationship occurs and a processing speed decreases.

In an aspect, it is an object to provide an arithmetic processing program and an arithmetic processing method capable of speeding up parallel operations of a sparse matrix.

Hereinafter, embodiments of an arithmetic processing program and an arithmetic processing method disclosed herein will be described in detail based on the figures. This disclosure is not limited by the embodiments. The embodiments may be combined with each other as appropriate within the scope without contradiction.

### Embodiment 1

### Description of Information Processing Apparatus

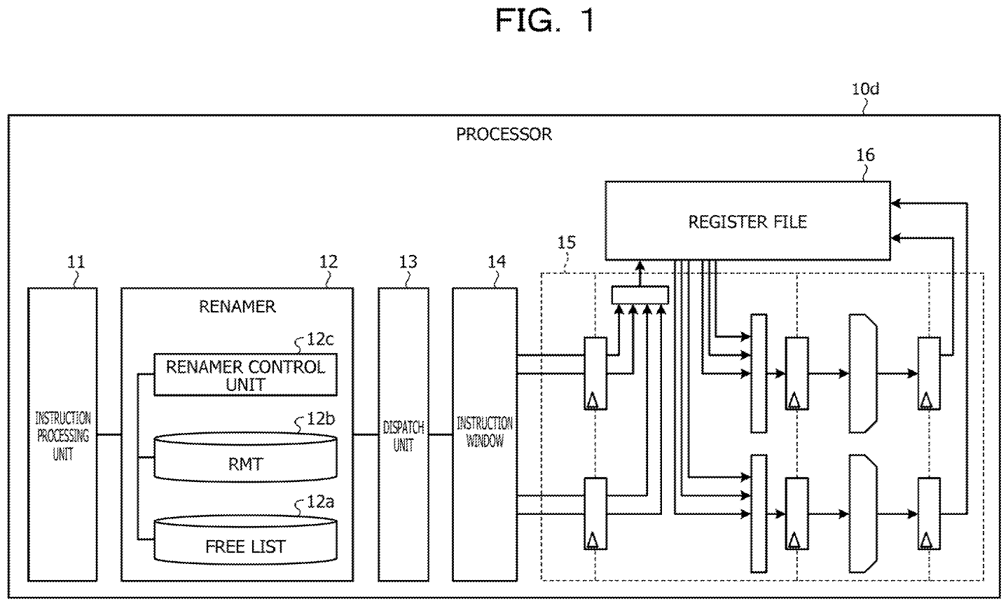

FIG. 1 is a functional block diagram illustrating a functional configuration included in a processor 10d of an information processing apparatus according to Embodiment 1. An information processing apparatus 10 illustrated in FIG. 1 is an example of an information processing apparatus such as a computer or a server. The processor 10d of the information processing apparatus speeds up solution processing of a system of linear equations of a sparse matrix (for example, a large-scale sparse matrix) by parallelization using SIMD. At this time, the processor 10d, while using a feature of a reduced instruction set computer (RISC)-V mask, changes processing of a renamer to resolve a dependency relationship at the time of parallel execution.

As illustrated in FIG. 1, the processor 10d includes an instruction processing unit 11, a renamer 12, a dispatch unit 13, an instruction window 14, an arithmetic circuit 15, and a register file 16.

The instruction processing unit 11 is a processing unit that executes an instruction pipeline in which execution of one instruction is divided into a plurality of stages and a plurality of instructions are executed as in a flow production. For example, the instruction processing unit 11 executes functions of FETCHER that reads an instruction from a memory, DECODER that interprets the read instruction, or the like.

The renamer 12 is a processing unit that executes renaming of a register number of a mask register that holds a mask pattern when mask processing of RISC-V is executed. The renamer 12 includes a free list 12a, a register map table (RMT) 12b, and a renamer control unit 12c.

The free list 12a is a database that stores unused register numbers. For example, a register number of a released physical register is registered with the free list 12a. The free list 12a is managed in a first-in-first-out (FIFO) manner, thus a released register number is added to an end of the list, and a free physical register is extracted from a top of the list at the time of allocation.

The RMT 12b is a table representing mapping between logical registers and physical registers. The RMT 12b has entries corresponding to the number of logical registers, and one entry corresponds to one logical register. In each entry, a register number of a physical register being allocated to a logical register of the entry is recorded. A register number of a physical register extracted from the free list 12a is registered with the RMT 12b, and when an instruction is committed, release of a previously allocated physical register is executed.

The renamer control units 12c is a processing unit that executes rename processing when mask processing of an SIMD type operation is executed. Although details of the rename processing by the renamer control unit 12c will be described later, briefly describing, for example, the renamer control unit 12c sets each mask pattern for designating a mask operation to each of a plurality of mask bits that indicates a bit corresponding to each element of each row of a sparse matrix in a mask register used for the mask operation. The renamer control unit 12c expands a plurality of mask bits to which respective mask patterns are set in different areas (register number) of a physical register, respectively.

When calculating (performing operations on) respective elements of each row of the sparse matrix in parallel, the renamer control unit 12c specifies a mask bit to be stored in an area of a physical register corresponding to each element. As a result, by the processor 10d, a mask operation is executed in accordance with a mask pattern set to the specified mask bit.

Terms used in Embodiment 1 will be briefly described. A mask bit indicates a corresponding bit of each element of a mask register. A mask pattern indicates a pattern to be set to a corresponding bit, and for example, {1, 0, 1, 1}, {0, 0, 1, 1}, or the like, applies. A mask register is represented by “v0”, and a mask bit corresponds to a 0th bit of an element #0 of v0, a 1st bit of an element #1, or the like.

The dispatch unit 13 is a processing unit that executes an instruction being in a state of waiting, or the like, and has, for example, functions of DISPATCHER. For example, the dispatch unit 13 executes an instruction input by the instruction processing unit 11, after the rename processing is executed by the renamer 12.

An instruction window 14 is a processing unit that inputs an instruction executed by the dispatch unit 13 to the arithmetic circuit 15. For example, the instruction window 14 monitors a processing status of the arithmetic circuit 15, and inputs an instruction being in a state of waiting to the arithmetic circuit 15 at appropriate timing.

The arithmetic circuit 15 is a processing unit including a circuit that executes an instruction, and executes each of various types of arithmetic operations such as addition and subtraction. The register file 16 is a type of high-speed storage in which registers are integrated, and executes data storage or the like when an SIMD type operation is executed.

### Description of Underlying Technique

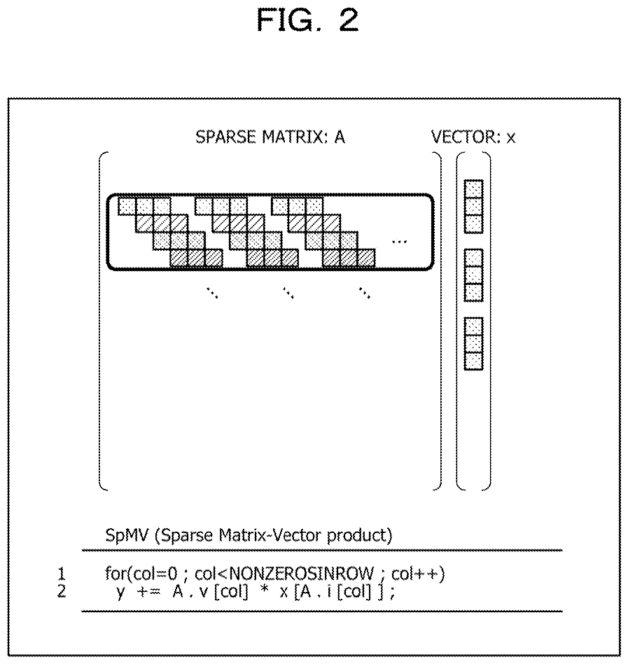

Next, various types of processing executed by the processor 10d in Embodiment 1 will be described. FIG. 2 is a diagram for explaining parallel operations of a sparse matrix according to Embodiment 1. As illustrated in FIG. 2, when a sparse matrix-vector multiplication (SpMV), which is an operation between respective elements (i) of a sparse matrix A and respective elements (v) of a vector x, is executed, the processor 10d performs arithmetic operations on a plurality of rows of the sparse matrix A at one time.

For example, the processor 10d executes an arithmetic expression “y+=A.v(col)×x(A.i(col))” in a loop of an index “col”. For example, the processor 10d acquires (stride-loads) “A.i” with the index “col” and executes gather-loading (x), acquires (stride-loads) “A.v” with the index “col”, executes fused multiply add (Fma) thereof, and stores a result in “y”.

### Mask Operation

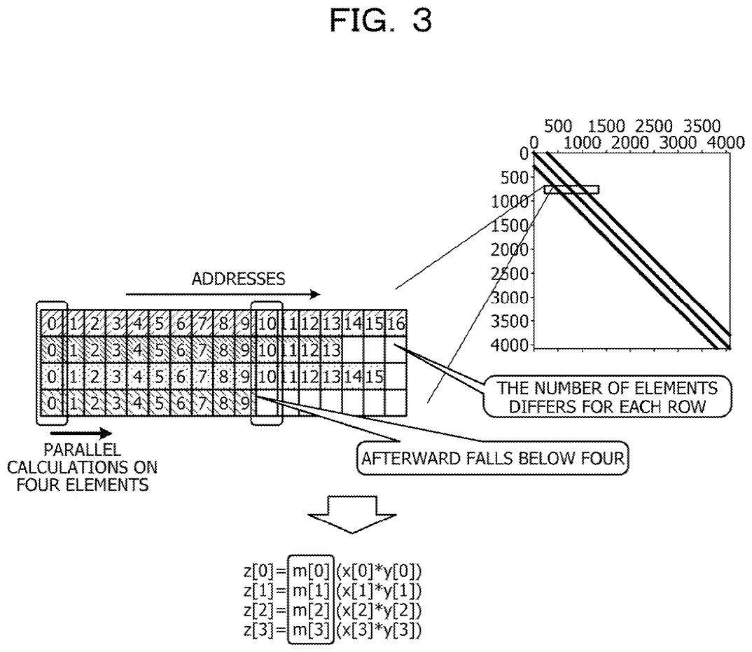

When executing the above arithmetic expression illustrated in FIG. 2 in parallel by SIMD, since the number of elements differs for each row of the sparse matrix A, the processor 10d executes a mask operation. FIG. 3 is a diagram for explaining the mask operation. As illustrated in FIG. 3, when performing parallel operations (parallel calculations) of four elements, the number of elements is less than four for elements 10 and subsequent elements, and the number of elements differs for each row. In such a case, the processor 10d executes the mask operation. For example, the processor 10d uses a mask vector such as {0, 1, 1, 1} and performs control so as not to execute an operation on an element for which “0” is set in the mask vector. In the example illustrated in FIG. 3, the processor 10d does not execute only calculation of z(0).

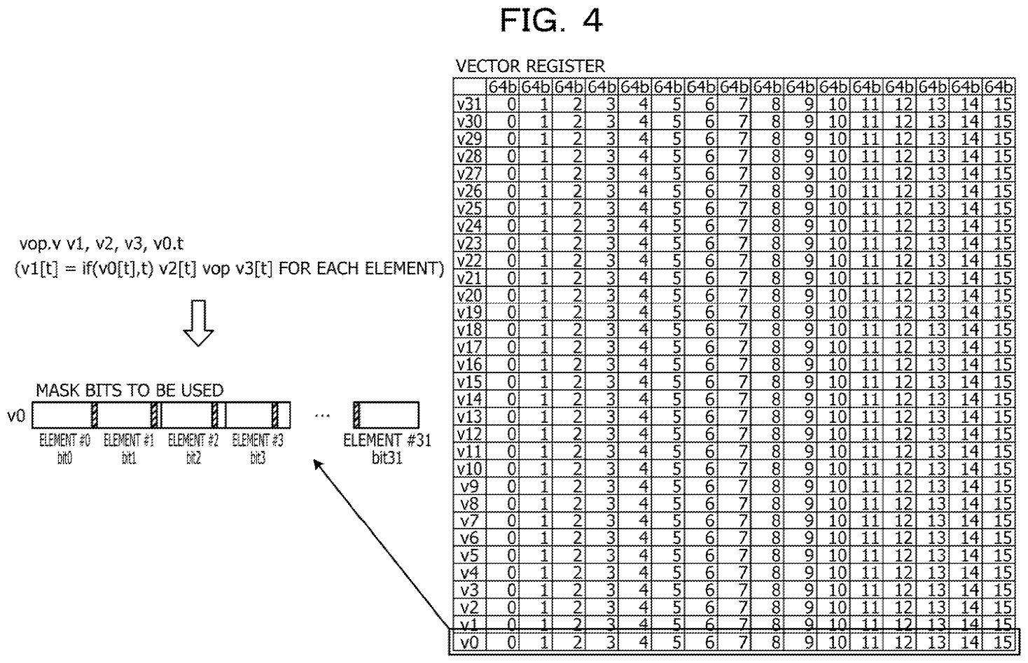

Mask processing of RISC-V will be described. FIG. 4 is a diagram for explaining an element mask of RISC-V. As illustrated in FIG. 4, the processor 10d uses, of a vector register having 32 areas from v0 to v31 separated by 64 bits, the No. 0 register “v0” as a mask register. The processor 10d executes “vop.v v1, v2, v3, v0.t”. The mask bit to be used is stored in an area corresponding to each element in the mask register v0. For example, a mask pattern for an element 0 is set to a bit 0 in an area of an element #0 of the mask register v0, a mask pattern for an element 1 is set to a bit 1 in an area of an element #1 of the mask register v0, and a mask pattern for an element 2 is set to a bit 2 in an area of an element #2 of the mask register v0.

In such a state, the processor 10d determines whether a “t-bit” which is a t-th element of v0 is “0” or “1” for each element, and executes the mask operation when the “t-bit” is “0”, and executes a normal operation when the “t-bit” is “1”. Note that “vop” is an operation of a vector instruction, and is addition, subtraction, or the like, for example.

In the mask operation described above, the mask pattern is to be changed in accordance with progress of the arithmetic operation, and execution of a code for creating a mask pattern in an innermost loop is requested, and thus influence on a reduction in a speed of the arithmetic operation, and deterioration in processing performance is large. For example, when mask generation processing is increased by two cycles inside a loop executed 100,000 times, performance deterioration for 200,000 cycles occurs. A mask pattern to be replaced in accordance with the progress of the arithmetic operation is to be prepared in advance, and to be stored in a logical register, thus a large number of logical registers are to be used, and the logical registers may be depleted.

### Implementation Example and Problem

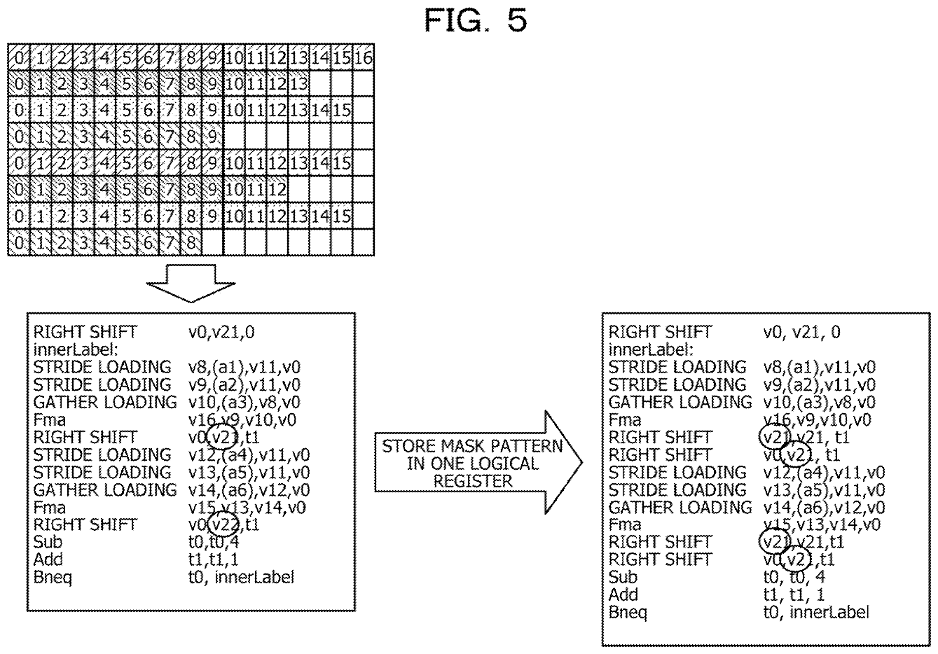

Next, an implementation example of assembly codes will be described. FIG. 5 is a diagram for explaining a problem due to replacement of a mask pattern. FIG. 5 illustrates an implementation example of assembly codes for executing rename processing and mask processing on a sparse matrix having 16 rows in which each row has eight elements. For example, in the assembly codes illustrated in FIG. 5, after a right shift “v0, v21, 0” for performing initial setting of a mask, processing contents are defined in a loop of innerLabel. For example, stride loading “v8, (a1), v11, v0” is an instruction to load indices to v8, v8 is a vector register that stores a result, a1 is an initial address of vector data, and v11 is index information indicating a plurality of addresses. The stride loading is regular loading, and gather loading is loading of random patterns.

Details of the assembly codes in FIG. 5 will be described. Operations on upper four elements are executed, by stride loading for loading indices for loading indices to v8, stride loading for loading values of a matrix to v9, gather loading for loading a vector x to v10, and Fma for executing a sum of products. Thereafter, a mask pattern is changed by a right shift, and operations on lower four elements are executed, by stride loading for loading indices for loading indices to v12, stride loading for loading values of a matrix to v13, gather loading for loading a vector x to v14, and Fma for executing a sum of products. Thereafter, a “right shift (v0, v22, t1)” for generating a mask for a next iteration, “Sub(t0, t0, 4)” for executing subtraction (index-=4) for an SIMD element, and “Add(t1, t1, 1)” for replacing the mask pattern are executed.

The logical register number v21 indicates mask patterns for the upper four elements (for example, {0x1FFF, 0x7FFE, 0x3FFC, 0x1FF8}, and the logical register number v22 indicates mask patterns for the lower four elements (for example, {0x0FFF, 0x7FFE, 0x1FFC, 0x0FF8}).

With a left diagram in FIG. 5, replacement of the mask pattern for the next iteration (from v21 to v22) occurs in the right shift after the processing of the upper four elements is executed, and thus a mask pattern is to be prepared in advance, and a large number of logical registers are consumed.

On the other hand, a right diagram in FIG. 5 illustrates an example in which a mask pattern is replaced with one logical register. In this case, although mask pattern replacement is not executed, right shifts are to be sequentially executed. For this reason, the same logical register is to be used, and a dependency relationship that a shift result of v21 is used occurs.

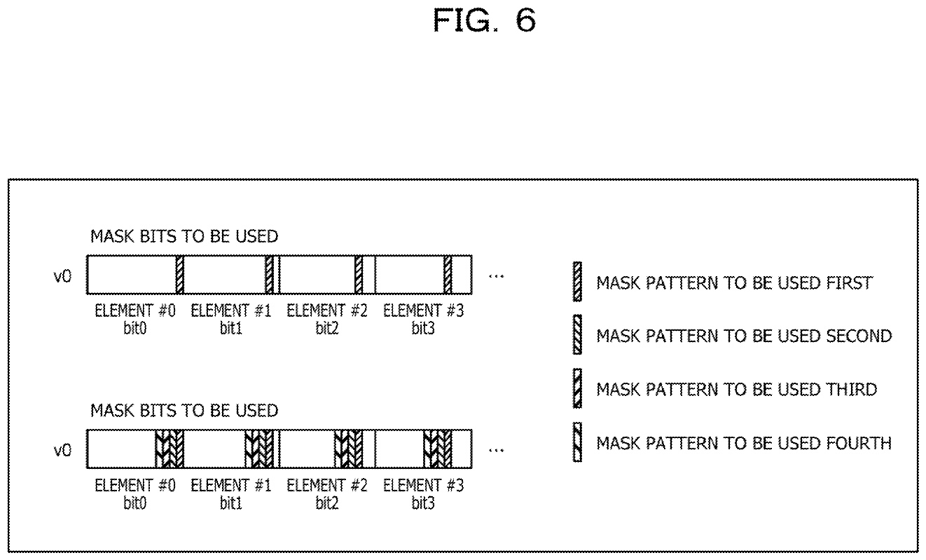

FIG. 6 is a diagram for explaining generation of a mask pattern by a right shift. As illustrated in FIG. 6, instead of the method described with reference to FIG. 4, the processor 10d stores a mask pattern for a right shift in each bit of each element of the mask register v0 such that a mask pattern to be used comes to a bit position to be used when a right one bit shift is executed. For example, a “mask pattern to be used first” is set in a bit 0 in an area of an element #0 of the mask register v0, a “mask pattern to be used second” is set in a bit 1, a “mask pattern to be used third” is set in a bit 2, and a “mask pattern to be used fourth” is set in a bit 3. A “mask pattern to be used first” is set in a bit 1 in an area of an element #1 of the mask register v0, a “mask pattern to be used second” is set in a bit 2, a “mask pattern to be used third” is set in a bit 3, and a “mask pattern to be used fourth” is set in a bit 4. “Used first” has the same meaning as “used after a right one bit shift”, and “used second” has the same meaning as “used after a right two bits shift”.

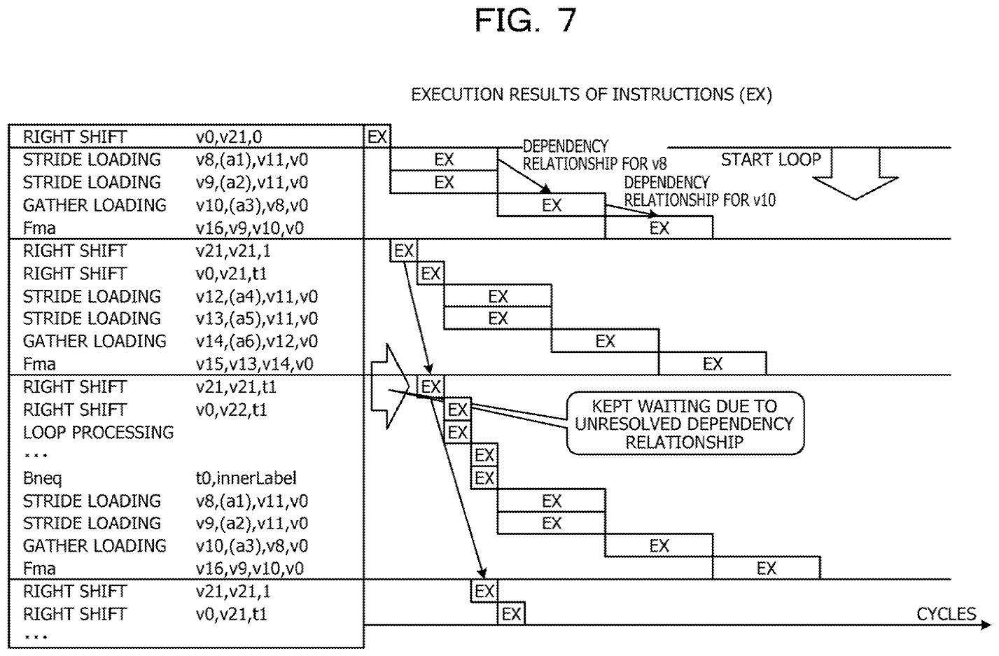

However, in this method, a dependency relationship occurs when the right shift is executed. FIG. 7 is a diagram for explaining occurrence of the dependency relationship. In FIG. 7, timing at which each instruction is executed is indicated by “Ex”. As illustrated in FIG. 7, since the “logical register number v21” is shared between right shifts, a dependency relationship occurs. For this reason, the right shifts are to be sequentially executed, which leads to a reduction in a processing speed.

### Rename Processing

According to the above-described method, the processing speed is reduced due to the right-shift dependency relationship, thus in order to resolve the right-shift dependency relationship, the processor 10d applies the rename processing by the renamer 12 to a mask register to resolve the dependency relationship.

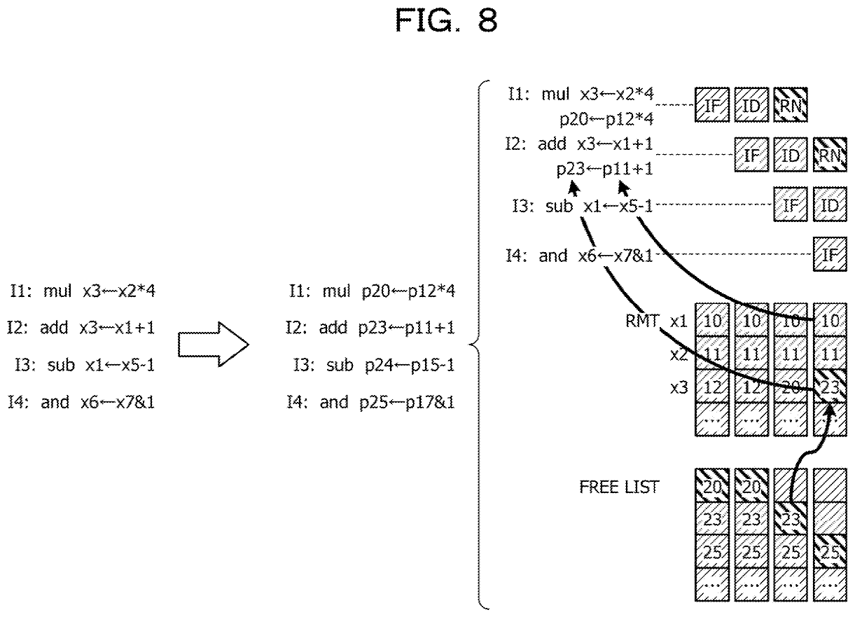

FIG. 8 is a diagram for explaining the rename processing. As illustrated in FIG. 8, in order to utilize a physical register having a capacity several times that of a logical register, the processor 10d executes rename processing for resolving a dependency relationship by reallocating x#, which is a register number in a program, to p#, which is a physical register number.

In the example illustrated in FIG. 8, the processor 10d specifies free physical register numbers in the free list 12a for arithmetic operations “I1:mul x3→x2×4”, “I2:add x3→x1+1”, “I3:sub x1→x5−1”, and “I4:and x6→x7&1”, and newly registers the free physical register numbers with the RMT 12b, thereby executing the rename processing of converting the arithmetic operations into “I1:mul p20→p12×4”, “I2:add p23→p11+1”, “I3:sub p22→p15−1”, and “I4:and p23—p17&1”. A right diagram in FIG. 8 illustrates the registration with the RMT 12b from the free list 12a, and the renaming of the arithmetic operations, and illustrates that, for example, p23 in the free list 12a is registered with the RMT 12b, and x3 of I2 is renamed with p23.

For example, the processor 10d renames the logical register numbers x3 having a dependency relationship between I1 and I2 to the physical register numbers p20 and p23, respectively, and renames the logical register numbers x1 having a dependency relationship between I2 and I3 to the physical register numbers p11 and p24, respectively, thereby resolving the right-shift dependency relationships and executing I1 to I4 in parallel.

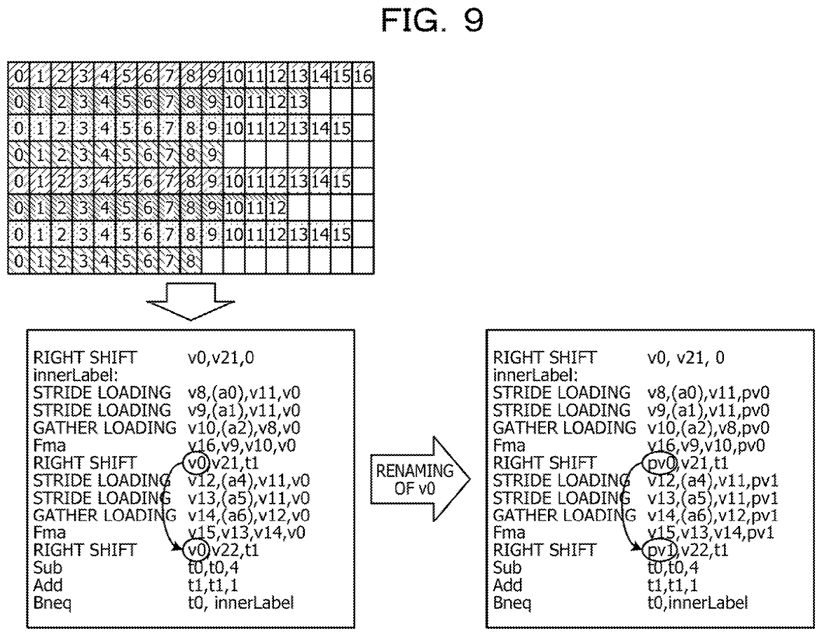

FIG. 9 is a diagram illustrating an example of resolving a dependency relationship by renaming. In FIG. 9, as in FIG. 5, an implementation example of assembly codes for executing rename processing and mask processing on a sparse matrix having 16 rows in which each row has eight elements will be described.

As illustrated in FIG. 9, the processor 10d, after a right shift which is initial setting of a mask executed outside a loop by the renamer 12 or the like, renames logical register numbers in right shifts in the loop. For example, the processor 10d renames the logical register number v0 in a first right shift in the loop to a physical register number pv0, renames the logical register number v0 in a second right shift in the loop to a physical register number pv1, and executes arithmetic operations. As a result, the processor 10d rewrites the logical register numbers, and thus may execute the two right shifts in parallel.

However, although the right-shift dependency relationship may be solved by this rename processing, since a large number of the logical registers are still used, a usage amount of the logical registers is large, and there is a high possibility that the logical registers are depleted.

Accordingly, in Embodiment 1, the processing by the renamer 12 is improved, and both the resolution of the right-shift dependency relationship and a reduction of the usage amount of the logical registers are achieved in a compatible manner. For example, the processor 10d breaks down a mask register bit by bit by the renamer 12, and allocates the broken-down bits to different physical registers.

### Improvement of Rename Processing

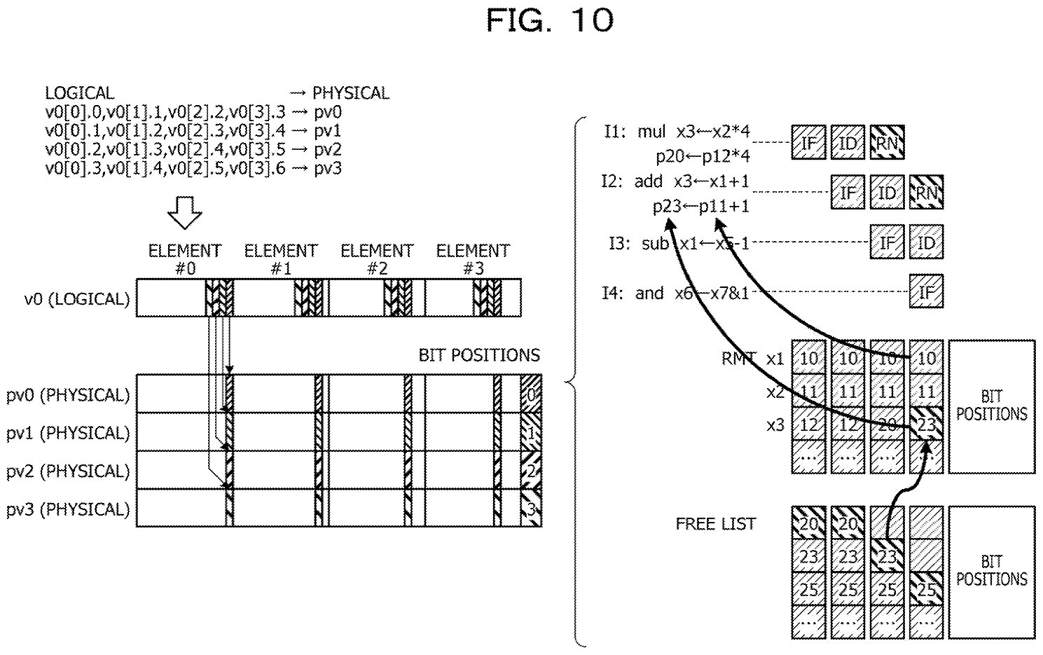

FIG. 10 is a diagram for explaining rename processing in Embodiment 1. As illustrated in FIG. 10, the processor 10d sets each mask pattern for specifying a mask operation to each of a plurality of mask bits that indicates a bit corresponding to each element of each row of a sparse matrix, in a mask register used for the mask operation. The processor 10d expands the plurality of mask bits to which the respective mask patterns are set in different areas (register numbers) of a physical register, respectively.

Thereafter, when performing arithmetic operations on respective elements in each row of the sparse matrix in parallel, the processor 10d specifies a mask bit to be stored in an area of a physical register corresponding to each element. According to the mask pattern set to the specified mask bit, the processor 10d executes the mask operation.

For example, as illustrated in FIG. 10, the processor 10d sets a mask pattern to a mask bit in an area corresponding to each element of the mask register v0 as in FIG. 6. For example, the processor 10d sets a “mask pattern to be used first” to a bit 0 of an area for an element #0 of the mask register v0 which is a logical register, a “mask pattern to be used second” to a bit 1, a “mask pattern to be used third” to a bit 2, and a “mask pattern to be used fourth” to a bit 3.

The processor 10d prepares pv0, pv1, pv2, pv3, and pv4 which are physical registers, and associates mask bit positions (0, 1, 2, 3) with the respective physical registers.

The processor 10d expands (arranges) a mask bit 0 of an element #0 of the mask register v0 in a mask bit 0 of an element #0 area of the physical register pv0, and expands a mask bit 1 of the element #0 of the mask register v0 in a mask bit 0 of an element #0 area of the physical register pv1. The processor 10d expands a mask bit 2 of the element #0 of the mask register v0 in a mask bit 0 of an element #0 area of the physical register pv2, and expands a mask bit 3 of the area of the element #0 of the mask register v0 in a mask bit 0 of an element #0 area of the physical register pv3.

Similarly, the processor 10d expands a mask bit 1 of an element #1 of the mask register v0 in a mask bit 1 of an element #1 area of the physical register pv0, and expands a mask bit 2 of the element #1 of the mask register v0 in a mask bit 1 of an element #1 area of the physical register pv1. The processor 10d expands a mask bit 3 of the element #1 of the mask register v0 in a mask bit 1 of an element #1 area of the physical register pv2, and expands a mask bit 4 for the element #1 of the mask register v0 in a mask bit 1 of an element #1 area of the physical register pv3.

Similarly, the processor 10d expands a mask bit 2 of the element #2 of the mask register v0 in a mask bit 2 of an element #2 area of the physical register pv0, and expands a mask bit 3 of the element #2 of the mask register v0 in a mask bit 2 of an element #2 area of the physical register pv1. The processor 10d expands a mask bit 4 of the element #2 of the mask register v0 in a mask bit 2 of an element #2 area of the physical register pv2, and expands a mask bit 5 of the element #2 of the mask register v0 in a mask bit 2 of an element #2 area of the physical register pv3.

Similarly, the processor 10d expands a mask bit 3 of an element #3 of the mask register v0 in a mask bit 3 of an element #3 area of the physical register pv0, and expands a mask bit 4 of the element #3 of the mask register v0 in a mask bit 3 of an element #3 area of the physical register pv1. The processor 10d expands a mask bit 5 of the element #3 of the mask register v0 in a mask bit 3 of an element #3 area of the physical register pv2, and expands a mask bit 6 of the element #3 of the mask register v0 in a mask bit 3 of an element #3 area of the physical register pv3.

For example, the processor 10d, when the mask bit to refer to is the bit 0, executes the mask processing using each mask pattern specified by each mask bit of pv0, and when the mask bit to refer to is the bit 1, executes the mask processing using each mask pattern specified by each mask bit of pv1. Similarly, the processor 10d, when the mask bit to refer to is the bit 2, executes the mask processing using each mask pattern specified by each mask bit of pv2, and when the mask bit to refer to is the bit 3, executes the mask processing using each mask pattern specified by each mask bit of pv3.

The processor 10d associates the mask bit positions (0, 1, 2, 3) also in the RMT 12b, and associates the mask bit positions (0, 1, 2, 3) also in the free list 12a. As a result, the processor 10d may manage which physical register is used at which bit position, thus it is possible to accurately restore a logical register number when restoring after the renaming.

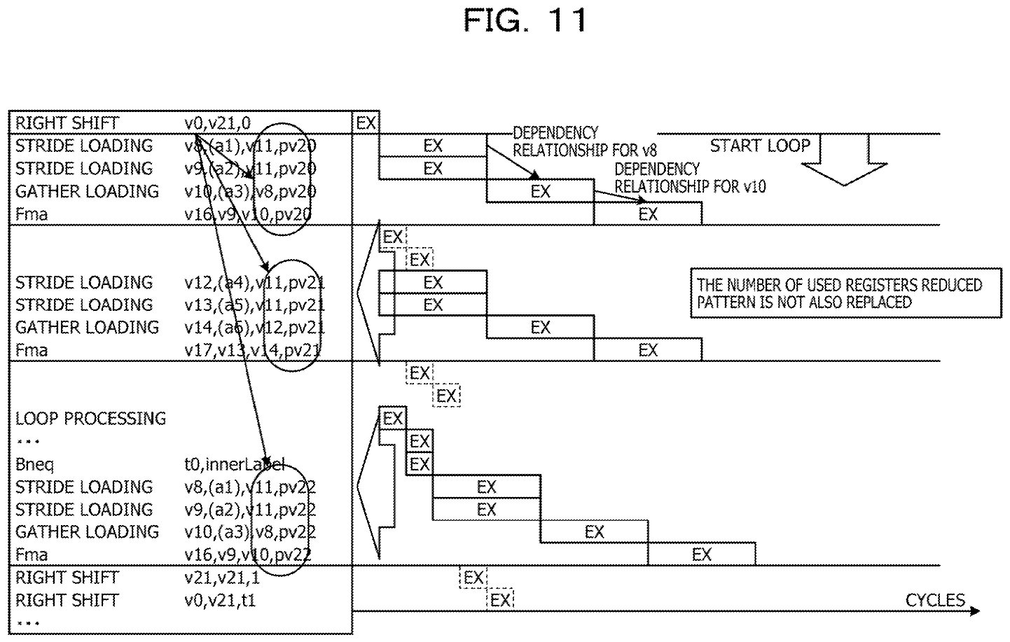

FIG. 11 is a diagram for explaining effects according to Embodiment 1. As illustrated in FIG. 11, after a right shift “v0, v21, 0”, which is a mask initial setting, the processor 10d may allocate “pv20” in the first arithmetic processing, allocate “pv21” in the next arithmetic processing, and allocate “pv22” in the next arithmetic processing, as mask registers. As a result, even when executing the right shifts of the respective arithmetic operations, the processor 10d is to access different physical registers, and thus it is possible to resolve a right-shift dependency relationship. The processor 10d may reduce a usage amount of logical registers.

Loop processing of assembly codes illustrated in FIG. 11 indicates an address update and an update of the number of loops, and because a scalar pipeline different from a vector is used parallel execution is possible. For example, an example of the address update is “Add a1, a1, t2”, “Add a2, a2, t2”, “Add a3, a3, t2”, “Add a4, a4, t2”, “Add a5, a5, t2”, “Add a6, a6, t2”, or the like. The update of the number of loops is, “Sub t0, to, 4” or “Add t1, t1, 1”.

### Flow of Processing

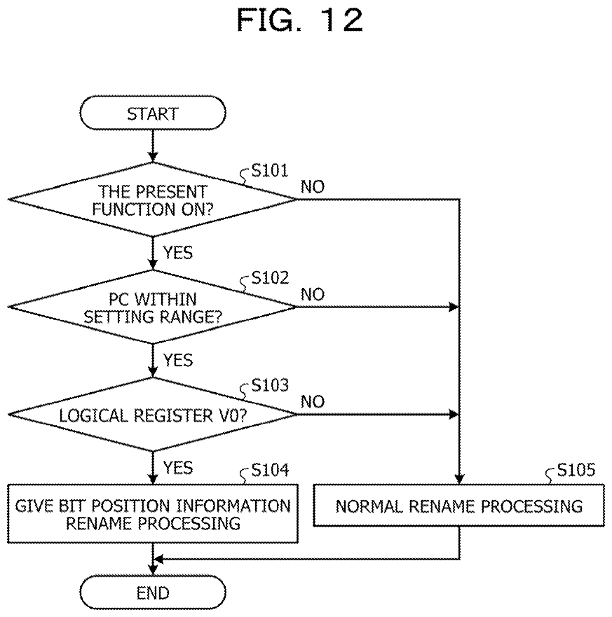

FIG. 12 is a flowchart for explaining a flow of the rename processing in Embodiment 1. As illustrated in FIG. 12, when the present function is ON (S101:Yes), a program counter (PC) is in a setting range (5102:Yes), and a logical register is v0 designated in advance (S103:Yes), the processor 10d executes the rename processing described with reference to FIGS. 10 and 11 for giving bit position information (S104). Thereafter, the processor 10d executes arithmetic processing while executing improved rename processing.

On the other hand, when the present function is not ON (S101:No), the program counter PC counter PC is not in the setting range (S102:No), or the logical register is not v0 designated in advance (S103:No), the processor 10d executes the normal rename processing described with reference to FIGS. 8 and 9 (S105). Thereafter, the processor 10d executes arithmetic processing while executing the normal rename processing.

For example, the processor 10d enables setting of ON or OFF of the function according to Embodiment 1, and enables specification of an application range by the program counter (PC) so as to operate only in a specific loop. The processor 10d limits a register to be expanded only to v0, and executes the expansion and the addition of the bit position information described above, only when the above conditions are satisfied.

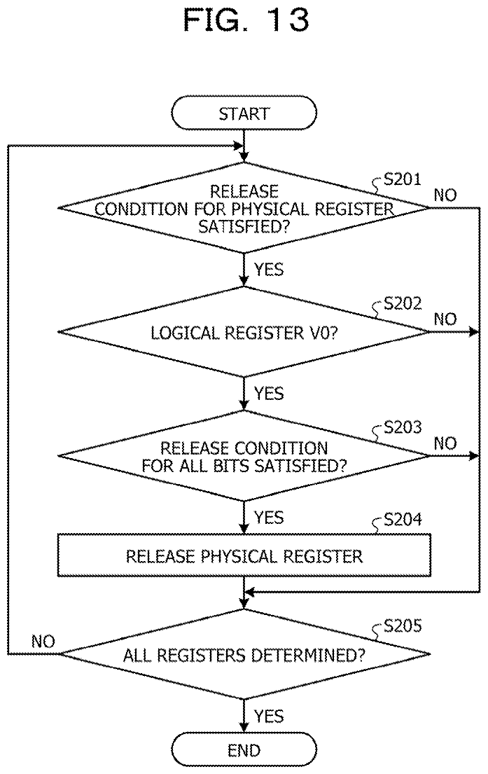

FIG. 13 is a flowchart for explaining a flow of release processing in Embodiment 1. As illustrated in FIG. 13, when a physical register satisfies a release condition (S201:Yes), a logical register is v0 (S202:Yes), and all bits satisfy a release condition (S203:Yes), the processor 10d releases the physical register used for the renamer (S204). Thereafter, when the release of all the physical registers used for the renamer is ended (S205:Yes), the processor 10d ends the release processing, and when there is a physical register yet to be released (S205:No), repeats S201 and subsequent steps.

For example, the processor 10d releases the allocated physical register at the time when the allocated physical register ends a role thereof as in a normal technique. In Embodiment 1, the processor 10d executes, in addition to normal release determination, additional determination as to whether a physical register to which mask information is allocated satisfies a normal release condition or not. For example, when a release target is vO, since there is a possibility that the renaming according to Embodiment 1 is applied to the release target, the processor 10d additionally checks details. For example, since information of v0 is expanded in a plurality of physical registers, the processor 10d determines whether all the physical registers may be released or not, based on bit position information. When, among physical registers tied up to the logical register v0, all with bit position information may be released, the processor 10d releases those physical registers.

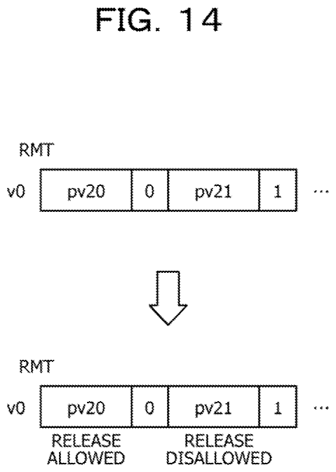

FIG. 14 is a diagram for explaining release determination in the release processing. An upper diagram of FIG. 14 illustrates the RMT 12b on which the rename processing according to Embodiment 1 is executed, and illustrates a state in which mask information of the mask register v0 is expanded in pv20 and pv21. pv20 indicates mask information obtained by right-shifting by zero bits, and pv21 indicates mask information obtained by right-shifting by one bit.

Thereafter, as illustrated in a lower diagram of FIG. 14, when an arithmetic operation on the mask information of pv20 is already ended and may be released, but an arithmetic operation on the mask information of pv21 is not ended yet, it is determined not to be releasable by the processor 10d. For example, the processor 10d suppresses the release until the last mask operation is performed.

### Effects

As described above, the processor 10d may execute the parallel operation of the sparse matrix by using the physical registers having a larger capacity than that of the logical registers. When executing the renaming of the mask register used for the mask operation, the processor 10d may execute the renaming to the physical register. When executing the renaming to the physical register, the processor 10d may distribute and expand the respective mask bits of the mask register in the plurality of physical registers. As a result, the processor 10d may suppress usage of unnecessary logical registers while resolving the right-shift dependency relationship in association with replacement of the mask pattern, thus it is possible to achieve both the resolution of the right-shift dependency relationship and the reduction of the usage amount of the logical register in a compatible manner.

The processor 10d releases the physical register after the use of each physical register used for the mask operation is completed, thus it is possible to suppress a release of a physical register in the middle of an arithmetic operation, and to reduce occurrence of an arithmetic operation failure, or unnecessary processing such as re-renaming.

### Embodiment 2

### Numerical Values and the Like

The number of each register, the mask pattern, the mask bit, the arithmetic operation, the loop processing, and the like used in the above embodiment are merely examples and may be arbitrarily changed. The flow of processing described in each flowchart may also be changed as appropriate within the scope without contradiction. Examples of the processor 10d include a central processing unit (CPU), a microprocessor unit (MPU), and the like.

### System

The processing procedures, control procedures, specific names, and information including various types of data and parameters described and illustrated in the above specification and drawings may be arbitrarily changed unless otherwise specified.

The function of each component of each device illustrated in the drawings is conceptual, and the components do not have to be configured physically as illustrated in the drawings. For example, the specific form of distribution or integration of each device is not limited to that illustrated in the drawings. For example, the entirety or a part thereof may be configured by being functionally or physically distributed or integrated in an arbitrary unit according to various types of loads, usage states, or the like.

All or arbitrary part of the processing functions performed in each device may be realized by a central processing unit (CPU) and a program analyzed and executed by the CPU or may be realized as hardware using wired logic.

### Hardware

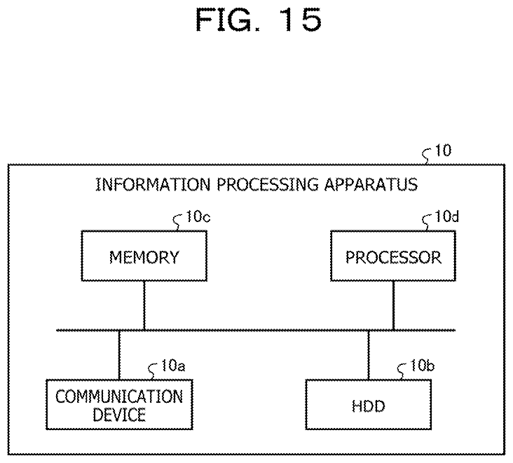

FIG. 15 is a diagram for explaining a hardware configuration example. As illustrated in FIG. 15, the information processing apparatus 10 includes a communication device 10a, a hard disk drive (HDD) 10b, a memory and the processor 10d. The units illustrated in FIG. 15 are coupled to one another by a bus or the like.

The communication device 10a is a network interface card or the like, and communicates with other apparatuses. The HDD 10b stores a program and a database (DB) for operating the functions illustrated in FIG. 1.

The processor 10d causes a process that executes each function described in FIG. 1 and the like to operate by reading from the HDD 10b or the like a program that executes processing similar to that performed by each processing unit illustrated in FIG. 1 and loading the read program to the memory For example, this process executes the functions similar to the function of each processing unit included in the information processing apparatus 10. For example, the processor 10d reads a program having the same functions as those of the renamer 12 from the HDD 10b or the like. The processor 10d executes a process that executes the same processing as that of the renamer 12.

As described above, the information processing apparatus 10 operates as an information processing apparatus that executes an information processing method by reading and executing a program. The information processing apparatus 10 may also realize the functions similar to those of the above-described embodiment by reading the above program from a recording medium with a medium reading device and executing the above read program. The program described in this other embodiment is not limited to being executed by the information processing apparatus 10. For example, the above embodiments may be similarly applied to a case where another computer or server executes the program or a case where such computer and server execute the program in cooperation with each other.

The program may be distributed over a network such as the Internet. The program may be recorded in a computer-readable recording medium such as a hard disk, a flexible disk (FD), a compact disc read-only memory (CD-ROM), a magneto-optical (MO) disk, or a Digital Versatile Disc (DVD), and may be executed by being read from the recording medium by a computer.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an arithmetic processing program for causing a computer to execute a process comprising:
setting, in a mask register used for a mask operation, to each of a plurality of mask bits that indicates a bit corresponding to each element of each row of a sparse matrix, each mask pattern for designating the mask operation; and
expanding the plurality of mask bits to which the respective mask patterns are set to different areas of a physical register, respectively.

2. The non-transitory computer-readable recording medium according to claim 1, further comprising:
specifying, when performing operations on respective elements in each row of the sparse matrix in parallel, the mask bit to be stored in an area of the physical register corresponding to each of the element; and
executing the mask operation in accordance with the mask pattern set to the mask bit specified.

3. The non-transitory computer-readable recording medium according to claim 1, wherein
the expanding,
when a program counter belongs to a setting range, expands the plurality of mask bits to different areas of the physical register, respectively,
when the program counter does not belong to a setting range, suppresses expansion to the physical register, and executes rename processing of the mask register to cause the mask operation to be executed.

4. The non-transitory computer-readable recording medium according to claim 1, further comprising:
releasing, when the mask operation corresponding to each of the plurality of mask bits expanded to different areas of the physical register, respectively, is completed, each of the different areas of the physical register.

5. An arithmetic processing method comprising:
setting, in a mask register used for a mask operation, to each of a plurality of mask bits that indicates a bit corresponding to each element of each row of a sparse matrix, each mask pattern for designating the mask operation; and
expanding the plurality of mask bits to which the respective mask patterns are set to different areas of a physical register, respectively.
